(19) United States
(12) Patent Application Publication
(10) Pub. No.: US 2001/0007822 A1
(43) Pub. Date: Jul. 12, 2001

(54) Paging system which a voids long distance and time dependent charges to the initiating party

(76) Inventor: Jackson M. Jobe, Lee, FL (US)

Correspondence Address: Law Office of Thomas C. Saitta, P.A., Suite 203, 6821 Southpoint Dr. North, Jacksonville, FL, 32216, US

(21) Appl. No.: 09/793,021

(22) Filed: Feb. 26, 2001

Related U.S. Application Data
(63) Continuation-in-part of application No. 08/994,538, filed on Dec. 19, 1997, now abandoned.

(51) Int. Cl. H04B 1/38; G08B 5/22; H04M 7/00; H04Q 1/30; H04Q 7/14; H04Q 7/00; H04M 1/00

(52) U.S. Cl. 455/556; 379/93.14; 379/233; 340/7.29

(57) ABSTRACT

A pager communications system which allows a pager message to be delivered to a pager from an initiating telephone without incurring long distance or time dependent charges, where an autopage switch having direct inward dial numbers delivers a particular preprogrammed message to a particular preprogrammed pager number in response to receipt of a call to one of the direct inward dial numbers.

This application is a continuation-in-part of U.S. patent application Ser. No. 08/994,538, filed Dec. 19, 1997, now abandoned.

### BACKGROUND OF THE INVENTION

This invention relates generally to the field of paging systems which provide for delivery of a message to a remote pager where the message is originally initiated by telephone. Also generally, the invention relates to a pager communications system where an initial telephone call is routed to a telephone autopage switch having a large number of direct inward dial (DID) telephone numbers and which is programmed to call a predetermined pager telephone number or to initiate delivery of an electronic message to a pager over a global computer network, i.e., the Internet, in response to the particular DID number called, without requiring that the initial call be identified as a connected call by the telecommunications system for billing purposes. More particularly, the invention relates to such systems where the autopage switch is programmed to send a particular message to a particular pager through a pager terminal solely in response to the particular DID number called, without creation of a completed billable connection on the incoming DID call.

The entry into the communications field of distinct communication devices and techniques, such as pagers, either voice or message, and cellular and PCS telephones, means that convenience in achieving communication has taken on new impetus. The proliferation of the various devices and systems has the unwanted drawback of sometimes complicating simple message delivery. A related problem, especially in foreign countries, is that many telephones are rotary dial phones which are unable to communicate a message to a pager where tone transmission is required. Also, the growth of the national and global marketplace has fueled the need for cost effective long distance and international communications. The telecommunications industry is expanding rapidly worldwide, but there are large differences in the costs of telecommunication from country to country. The United States, because of free market competitive factors and the fact that the networks are generally mature and well-capitalized, has telecommunication rates which are among the lowest in the world. To the contrary, many foreign countries have relatively new systems and systems operated by the government as a revenue generator for other programs, which result in high telecommunication rates for users in the foreign countries. This is especially true for international calls.

The discrepancy in such costs has resulted in the development of telecommunication systems which incorporate devices known as call back switches. Call back switches are programmed to dial a predetermined telephone number in response to receipt of call to a particular DID number without requiring that the original incoming call to the DID number actually be recognized by the telecommunications systems as being connected or completed. The initiating telephone caller then hangs up and the call back switch dials the programmed telephone number corresponding to the particular DID number, which is the number of the initiating telephone. When that telephone is answered, the call back switch provides an open line originating from the location of the call back switch or its network. The caller can now dial any telephone or pager number using the line provided by the call back switch. The advantage of this arrangement in international communications is significant. When a caller in a foreign country wants to initiate an international call to another party, there are two options. The call can be placed directly through the local telecommunications system in the standard manner simply by dialing the desired telephone number with the appropriate international calling prefix codes, thus incurring high long distance charging rates. Alternatively, the foreign caller can dial a pre-assigned, personal DID telephone number of a call back switch located in the United States, again through the local communications system using the appropriate international calling prefix codes. In this instance, the call back switch recognizes the DID telephone number without actually connecting the incoming call and the caller simply hangs up. This sequence registers as a non-completed call to the local system and no charges are incurred. The call back switch then calls the programmed telephone number corresponding to the DID number and provides an open line when the telephone is answered. The caller then dials the desired international telephone number in the usual manner. Since the open line provided by the call back switch originates in the United States, the user is charged the substantially lower U.S. rates regardless of the country of origination or the country being contacted.

While the system utilizing the call back switch is vastly superior from a cost standpoint, the caller is still charged long distance rates for each call, even if the duration of the call is extremely short. For example, under this system an international call placed to send a message to a pager would still be billed to the caller at long distance rates, usually on a time basis. It is an object of this invention to provide a pager communications system which mimics the cost saving advantages of a call back switch, but which enables a caller in a foreign country to deliver a message to a pager in a different country, or a caller to deliver a message to a pager within the same country, without incurring any long distance or time dependent charges. It is a further object to provide such a system where the caller can cause one of a predetermined list of messages to be transmitted to the pager without incurring long distance or time dependent charges. These and other objects are accomplished, as explained in more detail below, by providing a telecommunications system which incorporates an autopage switch having a large number of direct inward dial (DID) numbers and a programmed memory system, where the system is programmed to contact a specific pager number and deliver a specific message corresponding to the particular DID number dialed. An individual may be assigned a series of DID numbers, where each DID number contacts the same pager but leaves a different message. Alternatively, the autopage switch may be linked in communication to the Internet, such that the system is programmed to deliver the message over the Internet to a pager.

### SUMMARY OF THE INVENTION

The invention is a pager communications system which allows a caller to transmit a message to a pager by dialing a particular direct inward dial (DID) telephone number assigned to a telephone autopage switch. The autopage switch identifies the DID number without completing the call from the initiating telephone, i.e., the incoming call to the autopage switch is not acknowledged by the telecommunications system as a completed call, so no long distance charges are applied against the user's account by the local telecommunications provider. The system comprises a standard telecommunications network for transmission of calls, an autopage switch having a large number of assigned DID numbers, programmed memory means whereby each DID number corresponds to a particular pager number and a particular message for delivery, and a standard pager communications network, where the autopage switch dials the specific pager number corresponding to the particular DID number received and delivers the preprogrammed message to the pager, or communicates over the Internet and delivers the preprogrammed message to the pager.

To deliver a pager message to a pager without incurring long distance or time dependent charges, either within one country or internationally, a user dials a personal DID number associated with an autopage switch in the United States. The particular DID number dialed corresponds to a particular pager and to a particular predetermined message. For example, the DID number may correspond to a pager belonging to a business partner and the assigned message to this DID number may be the initiator's telephone number, or a coded, alphanumeric or pre-recorded voice message such as “call immediately”. The autopage switch identifies the DID number dialed by the caller without completing the call, in the sense that the telecommunications system does not acknowledge that the initiating call has made a connection to the autopage switch, so that the caller is not assessed charges by the local or foreign telecommunications provider. This is similar to the result when a long distance call is placed to a receiving telephone in use which has call waiting, or which has caller identification service, and the receiving party does not put the current call on hold to answer the incoming call or chooses not to accept the incoming call— the initiating caller is not assessed charges even though the telecommunications system has linked the initiating telephone and the receiving telephone to the extent that information, i.e., notice that an incoming call is occurring or notice of the identity of the incoming call, is provided to the receiving telephone. With the invention, the caller hangs up and the autopage switch then dials the pager number associated with the recognized DID number or connects through the Internet to a pager delivery system and, after communications contact with the pager is achieved, delivers the particular assigned message associated with the DID number to the pager. The caller may have a number of different personal DID numbers, all of which correspond to the same pager number but each of which deliver different predetermined messages, such as a different telephone number to be called by the recipient or alternate messages such as “call tomorrow”, “call main office”, etc.

### BRIEF DESCRIPTION OF THE DRAWINGS

FIG. 1 is a schematic drawing showing the pager communications system of the invention incorporating an initiating telephone, a telephone communication system, an autopage switch with programmed memory, a pager terminal and pager.

FIG. 2 is a diagram showing the routing of a pager message initiated by dialing a DID number to an autopage switch having programmed memory.

FIG. 3 is a schematic drawing similar to FIG. 1, which shows the pager communications system of the invention further incorporating a global computer network, i.e., the Internet.

### DETAILED DESCRIPTION OF THE INVENTION

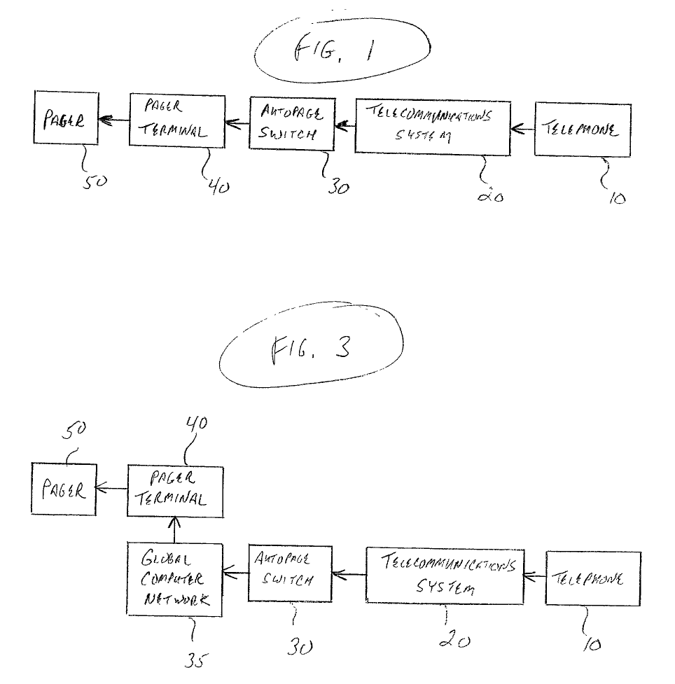

With reference to the drawings, the invention will now be described in detail with regard to the best mode and the preferred embodiment. As shown generally in FIGS. 1 and 3, the invention is a pager communications system comprised of a number of component members all communicating in standard known manner to effect long distance or international delivery of a message to a pager 50 initiated from a telephone 10. The telephone or equivalent initiating device 10 is connected to a common telecommunications system 20 allowing placement of a telephone call via land lines, radio wave, satellites, etc. to a receiving device having an assigned telephone number. In this case the receiving device is an autopage switch 30. The autopage switch 30 is in communication with a pager terminal 40, or a global communications network 35 in communication with a pager terminal 40 which transmits a message via radio waves to a pager 50.

The autopage switch 30 is a device which has the ability to recognize and identify a direct inward dial (DID) telephone number without requiring that the incoming call be connected, completed or answered, in a manner similar to the operation of a call back switch, along with means to initiate an outbound telephone call to a pager number, with the point of origin of the outbound call being the location of the autopage switch 30. A call from a telephone 10 to a DID number assigned to an autopage switch 30 does not register with the telecommunications system provider as a completed call as that term is defined for billing purposes, meaning that a long distance or time dependent (for billing purposes) call placed from a telephone 10 to an autopage switch 30 which is local, long distance or even in another country will not be billed to the initiating telephone 10, even though the autopage switch 30 has received information from the caller in the form of the identity of the DID number that was dialed. Based on this information, the autopage switch 30 automatically places a call to a particular number preprogrammed into the autopage switch 30, which is to a pager terminal 40 or global communications network 35 via a modem, for ultimate delivery of a predetermined message to a pager.

In the known telecommunication systems utilizing a call back switch, the call back switch is used to dial the initiating telephone 10 in response to the incoming DID call, and when the initiating telephone 10 is answered the call back switch provides an open line for the user to place an international call to another telephone number or a pager number in the standard manner. Since the open telecommunications line originates from the location of the call back switch, usually the United States, the user will be billed at rates much lower than the rates in its home country.

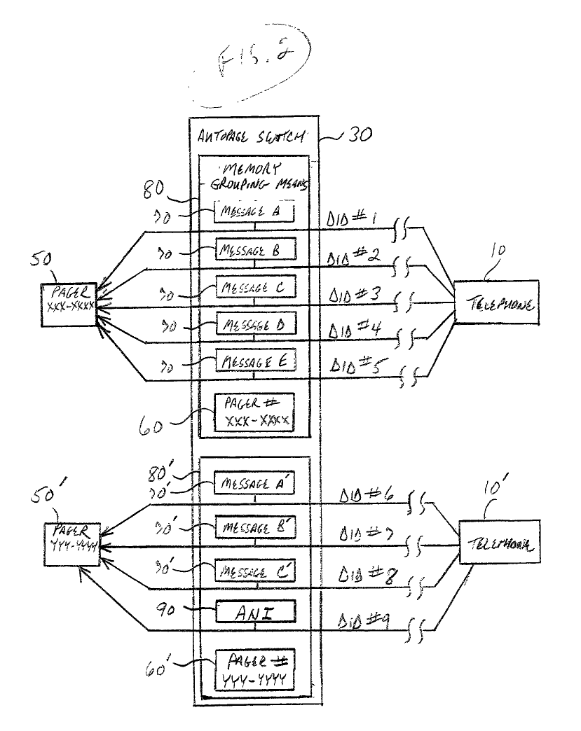

The invention improves on this standard system by providing an autopage switch 30 with a programmed memory grouping means 80, typically using a microprocessor and custom software, in place of the call back switch, as shown in FIG. 2. The memory grouping means 80 comprises means to store and associate a particular pager number 60 and a particular pager message 70 with a particular DID number, whereby the autopage switch 30 will dial the pager number 60 after receipt of the DID call from the initiating telephone 10. The outgoing call from the autopage switch 30 is routed to a pager terminal 40, either directly through standard telephone telecommunications systems or over the Internet via modem connection, which contacts the pager 50 associated with the pager number 60. When the communications channel to the pager 50 is open, the autopage switch 30 then delivers the message 70 to the pager 50.

The system allows a number of different DID numbers to be assigned to a particular subscriber. For example, subscriber A may be assigned DID numbers 1 through 5. The memory group 80 assigned to DID numbers 1 through 5 within autopage switch 30 is associated with a particular pager number 60. Each DID number is also individually associated with a particular preprogrammed message 70, denoted A through E. The messages 70 may comprise numeric messages, such as phone numbers or numeric codes, alpha-numeric messages, or recorded voice messages, depending on the capabilities of the pager system. When subscriber A wishes to transmit a particular message 70, for example message B, from a foreign country to a pager in another country or to a pager in a long distance calling zone within the same country, including within the U.S., he dials DID number 2 to contact the autopage switch 30. The autopage switch 30 recognizes the DID number, i.e., the autopage switch 30 receives a minimal amount of information from the initiating telephone 10, but does not complete the connection in the sense that the telecommunications system 20 does not acknowledge that the initiating telephone 10 is connected to the autopage switch 30, i.e., the autopage switch 30 does not “answer” the incoming call. This is illustrated by the broken line in FIG. 2, and means that subscriber A incurs no long distance or time dependent charges from the local or foreign telecommunications provider. Autopage switch 30, having been initiated by DID number 2, accesses the information in memory group 80, which instructs it to dial pager number 60, shown designated as XXX-XXXX. When pager 50 is contacted, autopage switch 30 transmits message B to the pager 50. If subscriber A had dialed DID number 5, then message E would have been transmitted to pager 50.

A single autopage switch 30 can accommodate thousands of DID numbers. Thus subscriber B may initiate a call from telephone 10′ using one of his assigned DID numbers 6 through 8. By dialing DID number 6, for example, initiates the autopage switch 30 as described above, which accesses memory group 80′, which contains three messages 70′ designated A′ through C′ associated with pager number 60′, shown designated as YYY-YYYY. Pager 50′ is contacted and message A′ is delivered. In similar manner, a single subscriber could have multiple sets of assigned DID numbers for contacting different pagers 50. For example, subscriber A could have DID numbers 1 through 5 and DID numbers 6 through 8. The autopage switch 30 could also have DID numbers which activate the typical call back response, i.e., a subscriber could also have a particular assigned DID number which would cause the autopage switch 30 to call back initiating telephone 10 to provide an open line for voice communication charged at the rates prevalent in the country containing the autopage switch 30 rather than the initiating telephone 10.

Another variation for the system is possible where the initiating telephone 10 is part of a telecommunications system 20 which provides for automatic number identification (ANI), commonly referred to as caller ID. In that instance the autopage switch 30, upon recognition of a particular DID number, shown as DID number 9 in FIG. 2, could be programmed to identify the telephone number of the initiating telephone 10′ using ANI technology means 90 and then to deliver the identified telephone number as the message 70 to the pager 50′. This feature would allow the subscriber to instruct the pager owner to call the particular telephone 10′ at the subscriber's current location, as opposed to the preprogrammed number in one of messages A′ through C′.

A major advantage of the system incorporating an autopage switch 30 as described over a system having only a call back switch is that the autopage system 30 provides a means to deliver a pager message 70 from a rotary type telephone 10. Conventional systems require the use of a touch-tone telephone 10 to input the numerical information to the pager 50. In many developing countries touch-tone telephones 10 are not available, so there is no currently available means for the delivery of pager messages 70. Since the messages 70 are predetermined within the autopage switch 30 and the autopage switch 30 itself is capable of sending tone signals to the pager 50, it does not matter what type of telephone 10 is used to dial the DID number to initiate the transmission.

In an alternative embodiment as diagramed in FIG. 3, the autopage switch 30 is programmed to contact a global communications network 35, i.e., the Internet, through standard modem or similar protocols. The autopage switch 30 thus delivers the messages 70 to a carrier or public paging terminal connected to the Internet, which in turn assesses the pager 50. Likewise, the autopage switch 30 may deliver the message 70 to the receiving party's personal computer connected to the Internet, which in turn dials up the local public paging terminal and delivers the message 70 to the pager 50, or which delivers the message 70 as electronic mail to the receiving party's personal computer.

It is contemplated and understood that certain equivalents and substitutions for components or elements set forth above may be obvious to those skilled in the art, so the true scope and definition of the invention is to be as set forth in the following claims.

I claim:

1. A pager communications system comprising an initiating telephone, a telecommunications system for delivering a long distance or time dependent call from said telephone, where said long distance or time dependent call would normally incur long distance or time dependent charges to said initiating telephone upon completed connection of said call, an autopage switch having direct inward dial numbers and programmed to contact a pager terminal in response to a call from said initiating telephone to one of said direct inward dial numbers, a pager terminal to contact a pager, and a pager having a pager number, all linked in communicating manner, where said autopage switch recognizes each of said direct inward dial numbers and delivers a message to said pager without completing a connection with said initiating telephone which incurs long distance or time dependent charges for the call from said initiating telephone.

2. The system of claim 1, where said autopage switch further comprises memory grouping means to store and associate a particular message and a particular pager number with each of said direct inward dial numbers.

3. The system of claim 2, where said memory grouping means comprises a programmable microprocessor.

4. The system of claim 1, where said initiating telephone comprises a rotary telephone.

5. The system of claim 1, further comprising a global computer network, where said autopage switch connects to said pager terminal through said global computer network.

6. The system of claim 2, further comprising a global computer network, where said autopage switch connects to said pager terminal through said global computer network.

7. The system of claim 1, where said autopage switch further comprises automatic number identification technology, such that said message delivered to said pager is the telephone number of the initiating telephone.

8. The system of claim 2, where said autopage switch further comprises automatic number identification technology, such that said message delivered to said pager is the telephone number of the initiating telephone.

9. The system of claim 6, where said autopage switch further comprises automatic number identification technology, such that said message delivered to said pager is the telephone number of the initiating telephone.

10. A method of delivering a message to a pager from an initiating telephone without requiring a completed connection which would incur long distance or time dependent telephone charges to said initiating telephone, comprising:
providing a pager communications system comprising an initiating telephone, a telecommunications system for delivering a long distance or time dependent call from said initiating telephone, where said long distance or time dependent call would normally incur long distance or time dependent charges to said initiating telephone upon connection of said call, an autopage switch having direct inward dial numbers and programmed to contact a pager terminal in response to said call from said initiating telephone to one of said direct inward dial numbers, a pager terminal to contact a pager, and a pager having a pager number, all linked in communicating manner, where said autopage switch recognizes each of said direct inward dial numbers without completing a connection with said initiating telephone which incurs long distance or time dependent charges for the call from said initiating telephone,
dialing one of said direct inward dial numbers from said initiating telephone to cause said autopage switch to contact said pager, and hanging up said initiating telephone after said autopage switch recognizes said direct inward dial number but before said telecommunications system recognizes said call as a completed connection.

11. The method of claim 10, further comprising providing memory grouping means to store messages and to associate a particular message and a particular pager number with each of said direct inward dial numbers, such that dialing one of said direct inward dial numbers causes said autopage switch to deliver said particular message associated with said direct inward number dialed to said particular pager.

12. The method of claim 10, further comprising providing a global computer network in communication with said autopage switch and said pager terminal, where said step of dialing a pager number is accomplished over said global computer network.

13. A business model for delivering a message to a pager from an initiating telephone without requiring a completed connection which would incur long distance or time dependent telephone charges to said initiating telephone, comprising:
providing a pager communications system comprising an initiating telephone, a telecommunications system for delivering a long distance or time dependent call from said initiating telephone, where said long distance or time dependent call would normally incur long distance or time dependent charges to said initiating telephone upon connection of said call, a programmable autopage switch comprising a microprocessor and having direct inward dial numbers, a pager terminal to contact a pager, and a pager having a pager number, all linked in communicating manner,
programming said autopage switch to provide a distinct message associated with each said direct inward dial numbers, and further programming said autopage switch to contact a particular pager through said pager terminal in response to said call from said initiating telephone to one of said direct inward dial numbers to deliver said distinct message to said pager,
receiving one of said direct inward dial numbers from said initiating telephone to cause said autopage switch to contact said pager, said autopage switch recognizing said direct inward dial number before said telecommunications system identifies said call as a completed connection incurring long distance or time dependent telephone charges to said initiating telephone,
associating said one of said direct inward dial numbers with said distinct message and said particular pager, contacting said particular pager and delivering said distinct message to said particular pager.

14. The model of claim 13, further comprising providing a global computer network in communication with said autopage switch and said pager terminal, such that said distinct message is delivered to said particular pager through said global computer network.
